(19) United States
(12) Patent Application Publication
(10) Pub. No.: US 2005/0007622 A1
(43) Pub. Date: Jan. 13, 2005

(54) Method and apparatus for registering external device to be permitted to perform printing job, and method and apparatus for permitting external device to perform printing job using the same

(76) Inventor: Jong-un Jeong, Gyeonggi-do (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/887,492

(22) Filed: Jul. 9, 2004

(30) Foreign Application Priority Data
Jul. 10, 2003 (KR) 2003-46873

(51) Int. Cl. G06F 15/00; G06F 3/12; G06F 11/30

(52) U.S. Cl. 358/1.14; 358/1.16; 713/200

(57) ABSTRACT

A method and an apparatus for registering an external device to be permitted to perform a printing job and a method and an apparatus for permitting an external device to perform a printing job using the same are provided. The method of permitting an external device to perform a printing job includes receiving a printing order from the predetermined external device; deciding whether or not the predetermined external device has been registered as a printing permitted external device; and receiving images to be printed from the predetermined external device and executing printing of the images when the predetermined external device has been registered as a printing permitted external device. Therefore, with the methods and apparatuses, identification symbols of external devices connected to a printing apparatus are registered, printing with the printing apparatus is regulated so that only registered external devices can perform printing, and therefore the printing apparatus can determine and regulate whether or not a printing job is performed according to a printing order of an external device.

### PRIORITY

The present invention claims the benefit under 35 U.S.C. §119(a) of Korean Patent Application No. 2003-46873, filed on Jul. 10, 2003 in the Korean Intellectual Property Office, titled “Method and Apparatus for Registering External Devices to Permit to Perform Printing Job, and Method and Apparatus for Permitting External Device to Perform Printing Job Using the Same,” the entire contents of which are incorporated herein by reference.

### BACKGROUND OF THE INVENTION

1. Field of the Invention

The present invention relates to a printing apparatus which is connected to external devices having respective printable files, such as a digital camera, digital camcorder, a portable phone, a digital memory card or a digital video displayer, and prints images transmitted from the external devices. More particularly, the present invention is related to a method and an apparatus for registering an external device to permit the external device to perform a printing job so that only particular external devices that are authorized by the printing apparatus can perform respective printing jobs, and a method and an apparatus for permitting the external device to perform a printing job using the same.

2. Description of the Related Art

A printing apparatus including a conventional printer or a multi-function product (MFP) having a printing function comprises a central processing unit, a printing execution unit, a memory unit, an operation panel unit, an interface unit, and so on. The central processing unit generally controls the whole system according to preset programs. That is, the central processing unit interprets instructions input from the operation panel unit, transmits protocols to and receives protocols from an external device via the interface unit, and transmits images received from the external device to the printing execution unit and controls the printing unit so that the printing unit can print the images. The printing execution unit prints the images according to control instructions of the central processing unit. The memory unit stores operating programs and general control programs of the central processing unit, and stores data necessary for the central processing unit performing programs. The operation panel unit has a plurality of keys, and transmits key data to the central processing unit according to the operation of a predetermined key. The interface unit is connected to external devices and acts as a passage for communication of protocols and image data. Thus, the conventional printing apparatus connected to external devices performs the function of printing images transmitted from the external devices.

However, since the conventional printing apparatus passively performs printing operations according to printing orders requested by all the external devices, there is a problem in which the conventional printing apparatus must perform printing operations requested by some external devices which are not desired to perform printing jobs. Therefore, there is no known method to solve the problem when some external devices are not desired to be authorized to perform printing jobs.

### SUMMARY OF THE INVENTION

The present invention provides a method of registering particular external devices, among external devices connected to a printing apparatus, to be permitted to perform a printing job.

The present invention also provides a method of permitting particular external devices connected to a printing apparatus to perform a printing job using the external device registering method.

The present invention also provides an apparatus for registering an external device to be permitted to perform a printing job according to the external device registering method.

The present invention also provides an apparatus for permitting an external device to perform a printing job according to the printing job permitting method.

According to an aspect of the present invention, there is provided a method of registering an external device to be permitted to perform a printing job, the method being performed in a printing apparatus connected to the external device having a file to be printed and comprising: (a) storing an identification symbol of a predetermined external device when the predetermined external device is connected to the printing apparatus; and (b) registering the predetermined external device whose identification symbol was stored in the printing apparatus as a printing permitted external device.

According to another aspect of the present invention, there is provided a method of permitting an external device to perform a printing job using registration information of the external device that has been registered for printing using a predetermined method, the method comprising: (a) receiving a printing order from a predetermined external device; (b) deciding whether or not the predetermined external device has been registered as a printing permitted external device; and (c) receiving images to be printed from the predetermined external device and executing printing of the images when the predetermined external device has been registered as a printing permitted external device.

According to another aspect of the present invention, there is provided an apparatus for registering an external device to be permitted to perform a printing job, the apparatus being included in a printing apparatus connected to the external device having a file to be printed and comprising: an identification symbol storage instructing portion for generating instructions to store an identification symbol of the predetermined external device when the predetermined external device is connected to the printing apparatus; and a registration controlling portion for controlling registration of the predetermined external device whose identification symbol was stored as a printing permitted external device.

According to another aspect of the present invention, there is provided an apparatus for permitting an external device to perform a printing job, the apparatus being included in a printing apparatus and using registration information of printing permitted external devices registered using a predetermined apparatus, the apparatus comprising: a printing order receiving portion for receiving a printing order from a predetermined external device; a registration detecting portion for detecting whether or not the predetermined external device is registered as a printing permitted external device; and a printing executing portion for receiving images to be printed from the predetermined external device in response to the detected result of the registration detecting portion and executing printing of the images.

### BRIEF DESCRIPTION OF THE DRAWINGS

The above objects and advantages of the present invention will become more apparent by describing in detail exemplary embodiments thereof with reference to the attached drawings in which:

FIG. 1 is a flowchart illustrating an embodiment of a method of registering an external device to be permitted to perform a printing job according to an embodiment of the present invention;

FIG. 2 is a flowchart illustrating an embodiment of step 12 shown in FIG. 1;

FIG. 3 is a flowchart illustrating a method of permitting an external device to perform a printing job according to an embodiment of the present invention;

FIG. 4 is a block diagram illustrating an embodiment of an apparatus for registering an external device to permit to perform a printing job according to an embodiment of the present invention;

FIG. 5 is a block diagram illustrating an embodiment of the registration controlling portion shown in FIG. 4; and

FIG. 6 is a block diagram illustrating an embodiment of an apparatus for permitting an external device to perform a printing job according to an embodiment of the present invention.

Throughout the drawings, it should be understood that like reference numbers are used to depict like features and structures.

### DETAILED DESCRIPTION OF THE INVENTION

A method of registering an external device that is permitted to perform a printing job according to an embodiment of the present invention will now be described.

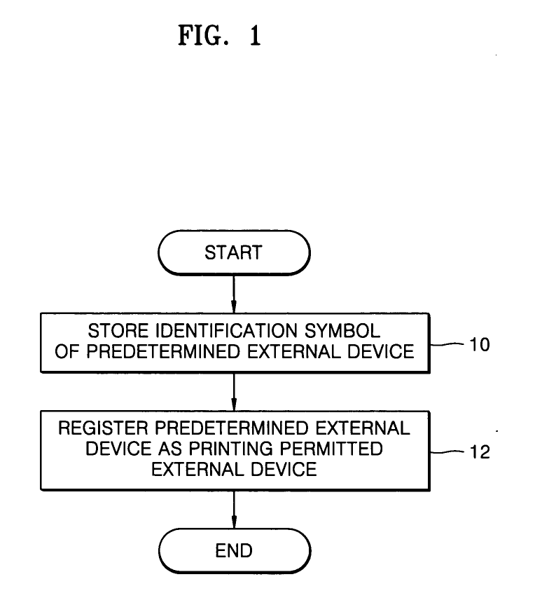

FIG. 1 is a flowchart of a method of registering an external device that is permitted to perform a printing job according to an embodiment of the present invention. The method includes storing an identification symbol of a predetermined external device and registering the external device as a printing permitted external device (steps 10 and 12).

Initially, an identification symbol of a predetermined external device is stored upon connection of the external device to a printing apparatus (step 10). The serial product number, identification number, or the like of the external device is automatically stored when the external device is connected to the printing apparatus. The identification symbol is used as information for registering the external device as a printing permitted external device in step 12. Examples of an external device that can be connected to the printing apparatus include a digital camera, a digital camcoder, a memory card, a personnel digital assistant (PDA), and a mobile phone, among others. These external devices may be directly connected to the printing apparatus by a universal serial bus (USB) or may be connected thereto via a wireless network.

After step 10, the external device having the identification symbol, which is stored, is registered as a printing permitted external device (step 12). A “printing permitted external device” refers to an external device, among a plurality of external devices connected to the printing apparatus, that is permitted to perform a printing job.

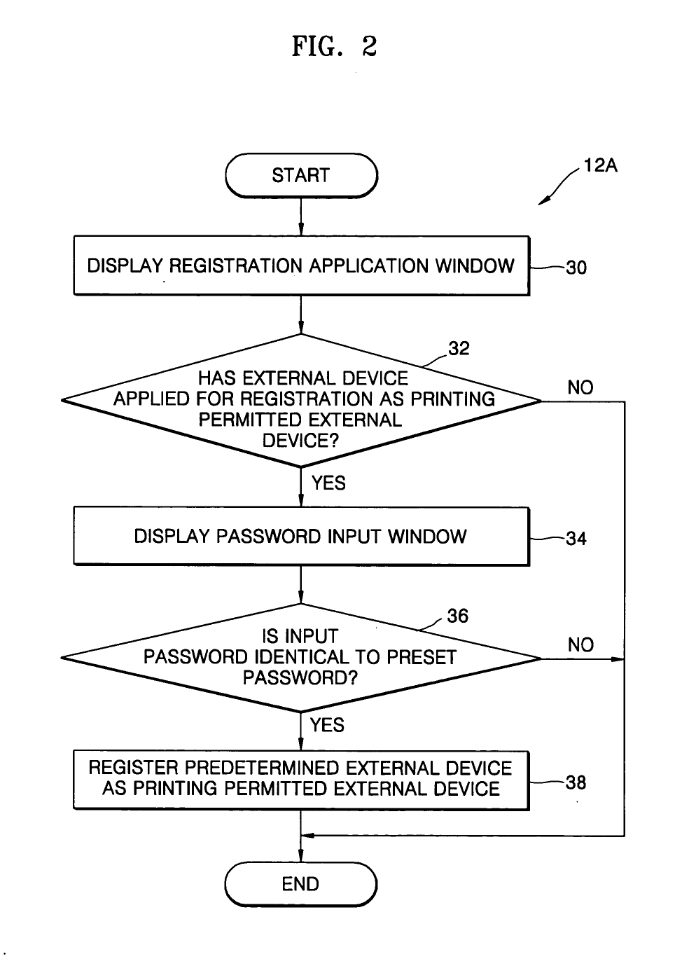

FIG. 2 is a flowchart illustrating an embodiment 12A of step 12 of FIG. 1. The embodiment 12A includes determining whether an input password is identical to a preset password and registering the predetermined external device as a printing permitted external device (steps 30 through 38).

Initially, a registration application window that is used to register the external device as the printing permitted external device is displayed (step 30). The registration application window is provided with a selection menu that allows a user to register the external device as a printing permitted external device. The registration application window is displayed on a display screen of the printing apparatus.

After step 30, it is determined whether a registration of the external device as the printing permitted external device has been applied for (step 32). If such a registration has not been applied for, the process is terminated.

However, if a registration of the external device as the printing permitted external device has been applied for, a password input window for inputting a preset password is displayed (step 34). The password input window is displayed on the display screen of the printing apparatus. The preset password stored in the printing apparatus is information used to authenticate a registration of the printing permitted printing apparatus among the plurality of external devices connected to the printing apparatus. After step 34, it is determined whether the password input through the password by the user is identical to the preset password stored in the printing apparatus (step 36).

If it is determined that the password input through the password input window is not identical to the preset password, the process is terminated and a registration of the external device as a printing permitted external device is denied.

However, if it is determined that the password input through the password input window is identical to the preset password, the external device is registered as a printing permitted external device using the identification symbol of the external device (step 38). If the password input through the password input window is identical to the preset password, the identification symbol stored in step 10 is used as information for registering the external device as the printing permitted external device.

A method of permitting an external device to perform a printing job according to an embodiment of the present invention will be described with reference to the attached drawing.

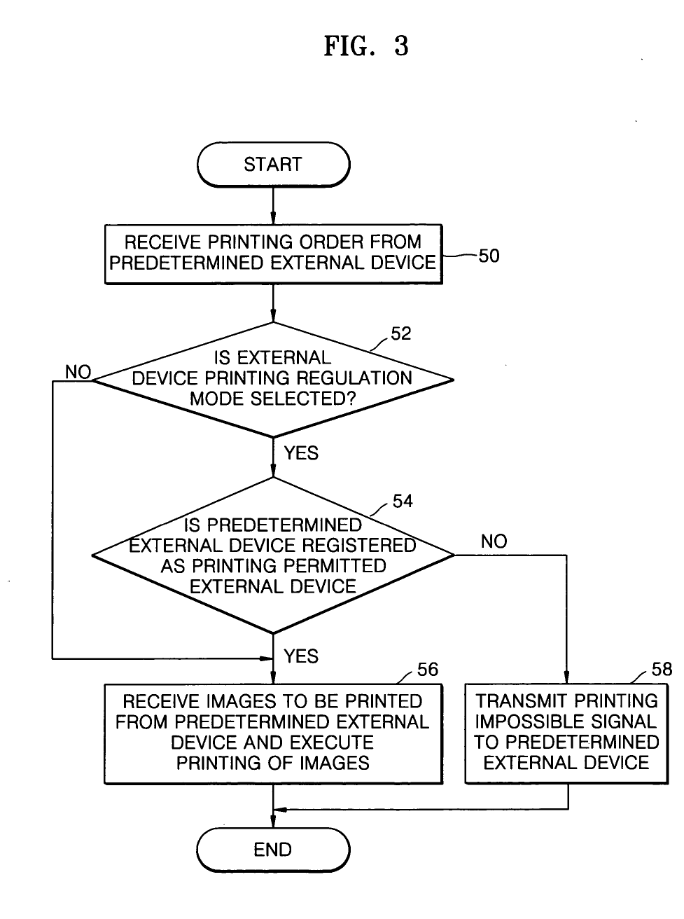

FIG. 3 is a flowchart illustrating a method of permitting an external device to perform a printing job according to an embodiment of the present invention.

Referring to FIG. 3, a method of permitting an external device to perform a printing job comprises the steps (step 50 to step 58) of deciding whether or not an external device printing regulation mode is selected, deciding whether or not a predetermined external device was registered as a printing permitted external device, and permitting the external device to perform a printing job or transmitting a printing impossible signal to the predetermined external device.

First, a printing apparatus receives a printing order from a predetermined external device (step 50). The printing apparatus receives the printing order to print images to be printed from the predetermined external device which is connected to the printing apparatus.

After step 50, whether or not the external device printing regulation mode is selected is determined (step 52). The external device printing regulation mode determines whether the printing apparatus performs printing jobs according to printing orders of all the external devices or whether the printing apparatus performs printing jobs only according to printing orders of the external devices that the printing apparatus permits to perform the printing jobs. Whether or not the external device printing regulation mode is selected by a user of the printing apparatus is determined.

When it is decided that the external device printing regulation mode is not selected, step 56 in which images to be printed are printed follows step 52. If the external device printing regulation mode is not selected, the printing apparatus is set to perform printing jobs according to printing orders of all the external devices connected to the printing apparatus. Therefore, the printing apparatus prints respective images to be printed according to the printing orders of all the external devices.

However, when it is determined that the external device printing regulation mode is selected, whether or not the predetermined external device is registered as a printing permitted external device is determined (step 54). The predetermined external device can be registered as a printing permitted external device according to the above-described method of registering an external device to permit to perform a printing job. By comparing the identification symbol of the predetermined external device with the registration information of the printing permitted external device registered in the printing apparatus, whether or not the predetermined external device was registered as a printing permitted external device can be determined.

When it is determined that the predetermined external device was registered as a printing permitted external device, the printing apparatus receives images to be printed from the predetermined external device and prints the images (step 56). When the predetermined external device was registered as a printing permitted external device, the printing apparatus is able to receive images to be printed from the predetermined external device. Therefore, the printing apparatus receives the images to be printed from the predetermined external device, and prints the images.

However, when it is determined that the predetermined external device was not registered as a printing permitted external device, the printing apparatus transmits a printing impossible signal to the predetermined external device (step 58). When the predetermined external device is not registered as a printing permitted external device, the predetermined external device is forbidden from performing a printing job using the printing apparatus. Therefore, the printing apparatus generates a printing impossible signal meaning that the images to be printed from the predetermined external device cannot be printed by the printing apparatus. The printing apparatus transmits the printing impossible signal to the predetermined external device.

Now, an apparatus for registering an external device to be permitted to perform a printing job according to an embodiment of the present invention will be described with reference to the attached drawings.

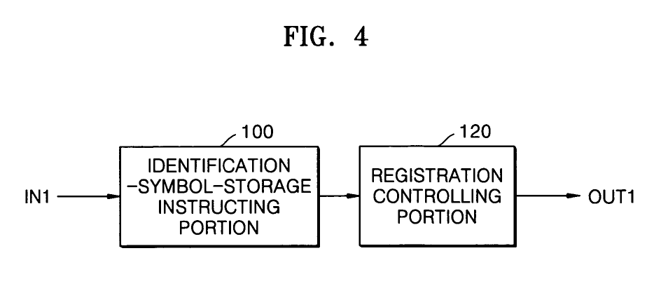

FIG. 4 is a block diagram illustrating an apparatus for registering an external device to permit to perform a printing job according to an embodiment of the present invention. The apparatus for registering an external device to be permitted to perform a printing job includes an identification-symbol-storage instructing portion 100 and a registration controlling portion 120.

When a predetermined external device is connected to the printing apparatus, the identification-symbol-storage instructing portion 100 generates instructions to store the identification symbol of the predetermined external device. A connection signal that the predetermined external device was connected to the printing apparatus is input to the identification-symbol-storage instructing portion 100 through an input terminal IN1. Responding to the input connection signal of the predetermined external signal, the identification symbol-storage-instructing portion 100 generates the instructions to store the identification symbol provided by the predetermined external device, and outputs the instructed result to the registration controlling portion 120. Accordingly, when the predetermined external device is connected to the printing apparatus, the identification symbol corresponding to the manufacture number, identification number, or the like of the predetermined external device is stored in a predetermined memory area (not shown) of the printing apparatus.

The registration controlling portion 120 controls registration of the predetermined external device whose identification symbol has been stored in the printing apparatus as a printing permitted external device. The registration controlling portion 120 receives the instructions from the identification-symbol-storage instructing portion 100 and then controls registration of the predetermined external device whose identification symbol was stored in the printing apparatus so that it can be registered as a printing permitted external device, and outputs the controlled result through an output terminal OUT1.

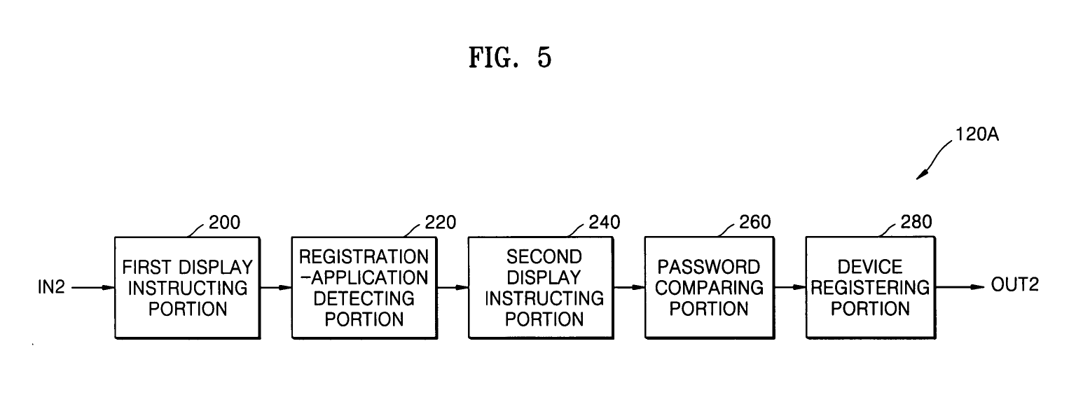

FIG. 5 is a block diagram illustrating an embodiment 120a of the registration controlling portion 120 shown in FIG. 4. The registration controlling portion 120a comprises a first display instructing portion 200, a registration-application detecting portion 220, a second display instructing portion 240, a password comparing portion 260, and a device registering portion 280.

The first display instructing portion 200 generates instructions to display a registration application window for the predetermined external device to apply for a registration as a printing permitted external device. The registration application window is, provided with a selection menu enabling a user of the predetermined external device to apply for registration of the predetermined external device as a printing permitted external device. Therefore, the first display instructing portion 200 receives input of the result of the identification-symbol-storage instructing portion 100 generating the instructions to store the identification symbol through an input terminal IN2, thereafter generates instructions to display the registration application window, and outputs the instructed result to the registration-application detecting portion 220.

The registration-application detecting portion 220 detects whether or not the predetermined external device has applied for a registration as a printing permitted external device. The registration-application detecting portion 220 receives the instructed result from the first display instructing portion 200 to display the registration application window, thereafter detects whether or not the user of the predetermined external device applies for registration of the predetermined external device as a printing permitted external device by means of the registration application window, and outputs the detected result to the second display instructing portion 240.

The second display instructing portion 240 generates instructions to display a password input window to which a preset password stored in the printing apparatus can be input. The preset password stored in the printing apparatus is information requisite for an approval procedure for checking whether or not any one of external devices connected to the printing apparatus can be registered as a printing permitted external device. The second display instructing portion 240 receives input of the detected result of the registration application from the registration-application detecting portion 220, thereafter generates instructions to display the password input window, and outputs the instructed result to the password comparing portion 260. The password comparing portion 260 compares an input password with the preset password and checks whether or not the input password is the same as the preset password. The password comparing portion 260 receives input of the second display instructing portion 240, thereafter compares the password input by the user by means of the password input window with the preset password and checks whether or not the input password is the same as the preset password, and outputs the compared result to the device registering portion 280.

The device registering portion 280 registers the predetermined external device as a printing permitted device using the identification symbol of the predetermined external device. The device registering portion 280 receives input of the compared result from the password comparing portion 260, thereafter registers the predetermined external device as a printing permitted device using the identification symbol of the predetermined external device, and outputs the registered result through an output terminal OUT2.

Now, an apparatus for permitting an external device to perform a printing job according to an embodiment of the present invention will be described with reference to the attached drawings.

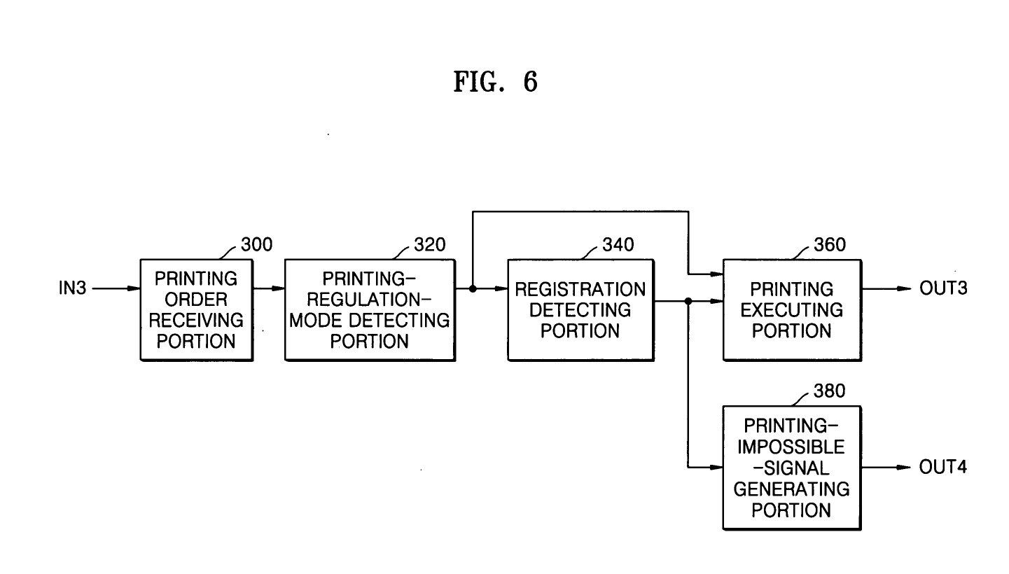

FIG. 6 is a block diagram illustrating an apparatus for permitting an external device to perform a printing job according to an embodiment of the present invention. The apparatus for permitting an external device to perform a printing job comprises a printing order receiving portion 300, a printing-regulation-mode detecting portion 320, a registration detecting portion 340, a printing executing portion 360, and a printing-impossible-signal generating portion 380.

The printing order receiving portion 300 receives a printing order from a predetermined external device. The printing order receiving portion 300 receives the printing order input from the predetermined external device through an input terminal IN3, and outputs the received result to the printing-regulation-mode detecting portion 320.

The printing-regulation-mode detecting portion 320 detects whether or not the external device printing regulation mode is selected. An arbitrary operation key of the above-described operation panel portion can be allocated as a means for selecting the external device printing regulation mode. Therefore, the external device printing regulation mode can be selected by a key operation of the user of the printing apparatus, and the printing-regulation-mode detecting portion 320 detects whether or not the external device printing regulation mode is selected by a key operation of the user. The printing-regulation-mode detecting portion 320 receives input of the received result from the printing order receiving portion 300, and thereafter outputs the determined result that the external device printing regulation mode was selected or external device printing regulation mode was not selected to the registration detecting portion 340 and the printing executing portion 360. The registration detecting portion 340 determines whether or not the predetermined external device is registered as a printing permitted external device. The registration detecting portion 340 receives input of the determined result that the external device printing regulation mode was selected from the printing-regulation-mode detecting portion 320, and thereafter outputs the determined result that the predetermined external device was registered as a printing permitted external device or that the predetermined external device was not registered as a printing permitted external device to the printing executing portion 360 and the printing-impossible-signal generating portion 380.

Responding to the determined result of the registration detecting portion 340, the printing executing portion 360 receives images to be printed from the predetermined external device, and executes printing of the images. Responding to the determined result input from the registration detecting portion that the predetermined external device was registered as a printing permitted external device, the printing executing portion 360 receives the images to be printed from the predetermined external device and executes printing of the images, and outputs the executed result through an output terminal OUT3. On the other hand, the printing executing portion 360 receives the determined result input from the printing-regulation-mode detecting portion 320 that the external device printing regulation mode was not selected, thereafter receives the images to be printed from the predetermined external device and executes printing of the images, and outputs the executed result through an output terminal OUT3.

Responding to the determined result of the registration detecting portion, the printing-impossible-signal generating portion 380 generates a printing impossible signal, and transmits the generated printing impossible signal to the predetermined external device. When the predetermined external device is not registered as a printing permitted external device, the predetermined external device is prohibited printing with the printing apparatus. The printing impossible signal is a signal meaning that images to be printed of the predetermined external device cannot be printed by the printing apparatus. The printing-impossible-signal generating portion 380 receives input of the determined result input from the registration detecting portion 340 that the predetermined external device is not registered as a printing permitted external device, thereafter generates the printing impossible signal, and outputs the generated printing impossible signal to the predetermined external device through an output terminal OUT4.

As described above, in the method and the apparatus for registering an external device to permit to perform a printing job, and the method and apparatus for permitting an external device to perform a printing job using the same according to embodiments of the present invention, identification symbols of external devices connected to a printing apparatus are registered, printing with the printing apparatus is regulated so that only registered external devices can perform printing, and therefore the printing apparatus can decide and regulate whether or not a printing job is performed according to a printing order of an external device.

1. A method of registering an external device to be permitted to perform a printing job, the method being performed in a printing apparatus connected to the external device having a file to be printed and comprising the steps of:
(a) storing an identification symbol of a predetermined external device when the predetermined external device is connected to the printing apparatus; and
(b) registering the predetermined external device whose identification symbol was stored in the printing apparatus as a printing permitted external device.

2. The method according to claim 1, wherein the registering step comprises:
displaying a registration application window for applying for a registration of the predetermined external device as a printing permitted device;
deciding whether or not the predetermined external device has applied for a registration as a printing permitted external device;
displaying a password input window through which a preset password stored in the printing apparatus is input when it is determined that the predetermined external device has applied for a registration as a printing permitted external device;
deciding whether or not a password input through the password input window is identical to the preset password; and
registering the predetermined external device as a printing permitted external device using the identification symbol of the predetermined external device when the password input through the password input window is identical to the preset password.

3. A method of permitting an external device to perform a printing job using registration information of the external device that has been registered for printing using a predetermined method, the method comprising:
(a) receiving a printing order from a predetermined external device;
(b) deciding whether or not the predetermined external device has been registered as a printing permitted external device; and
(c) receiving images to be printed from the predetermined external device and executing printing of the images when the predetermined external device has been registered as a printing permitted external device.

4. The method according to claim 3, further comprising, after the receiving step, determining whether an external device printing regulation mode is selected, wherein the process goes to step (b) if the external device printing regulation mode is selected, and the process goes to step (c) if the external device printing regulation mode is not selected.

5. The method of claim 3, further comprising transmitting a printing impossible signal to the predetermined external device if it is determined in step (b) that the predetermined external device has not been registered as a printing permitted external device.

6. An apparatus for registering an external device to be permitted to perform a printing job, the apparatus being included in a printing apparatus connected to the external device having a file to be printed and comprising:
an identification symbol storage instructing portion for generating instructions to store an identification symbol of the predetermined external device when the predetermined external device is connected to the printing apparatus; and
a registration controlling portion for controlling registration of the predetermined external device whose identification symbol was stored as a printing permitted external device.

7. The apparatus according to claim 6, wherein the registration controlling portion comprises:
a first display instructing portion for generating instructions to display a registration application window for the predetermined external device to apply for registration as a printing permitted external device;
a registration-application detecting portion for detecting whether or not the predetermined external device has applied for a registration as a printing permitted external device by means of the registration application window;
a second display instruction portion for generating instructions to display a password input window to allow a preset password stored in the printing apparatus to be input;
a password comparing portion for comparing the password input by means of the password input window with the preset password and checking whether or not the input password is identical to the preset password; and
a device registering portion for registering the predetermined external device as a printing permitted device using the identification symbol of the predetermined external device.

8. An apparatus for permitting an external device to perform a printing job, the apparatus being included in a printing apparatus and using registration information of printing permitted external devices registered using a predetermined apparatus, the apparatus comprising:
a printing order receiving portion for receiving a printing order from a predetermined external device;
a registration detecting portion for detecting whether or not the predetermined external device is registered as a printing permitted external device; and
a printing executing portion for receiving images to be printed from the predetermined external device in response to the detected result of the registration detecting portion and executing printing of the images.

9. The apparatus of claim 8, further comprising a printing-impossible-signal generating portion for generating a printing impossible signal in response to the detected result of the registration detecting portion and transmitting the printing impossible signal to the predetermined external device.

10. The apparatus of claim 8, further comprising a printing-regulation-mode detecting portion for detecting whether or not an external device printing regulation mode is selected.
